(19) United States
(12) Patent Application Publication
(10) Pub. No.: US 2010/0088964 A1
(43) Pub. Date: Apr. 15, 2010

(54) SNAP-IN GLASS RETENTION FOR A VEHICLE DOOR

(75) Inventors: Terrence P. Costigan, Fenton, MI (US); Gavin J. Brownlie, JR., Sterling Heights, MI (US); Andrew J. Stone, Troy, MI (US); John D. Caron, St.Clair Shores, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., Detroit, MI (US)

(21) Appl. No.: 12/248,948

(22) Filed: Oct. 10, 2008

(51) Int. Cl. E05F 11/38; E06B 7/28

(52) U.S. Cl. 49/372; 248/316.7

(57) ABSTRACT

A snap-in glass carrier engageable with a window regulator assembly for snap fitting a movable door glass with a glass retention hole to the glass carrier is disclosed. The glass carrier may comprise a glass carrier base and a spring finger. The spring finger may extend in a cantilevered fashion from the base and include a barb spaced from the base and engaged with the retention hole. The spring finger may also include a spring finger neck adjacent to the base and connecting to the base at an attachment location, with the spring finger neck being tapered and having a curvature configured to align the attachment location directly under an edge of the glass when the glass is mounted to the glass carrier. The snap-in glass carrier may also include saber-toothed ribs under the barb and a support bridge for the spring finger.

### BACKGROUND OF INVENTION

The present invention relates generally to movable windows in vehicle doors and more particularly to glass carriers for movable windows in vehicle doors.

Snap-in side glass retainers have been employed to retain movable glass in automotive vehicle doors. However, one limitation of these snap-in glass retainers is their inability to retain the glass to the retainer when the glass is frozen in its full up position and an abusive reversal load is input to a manual regulator. And, in particular, for rear side doors with single guided manual regulators (the worst case condition due to the reversal load going into a single snap feature) the reversal loads can reach 700 newtons on the glass retainer. Thus, for these configurations, a conventional glass retention assembly with a clamp type mechanism is employed to withstand the loading. But the clamp type mechanisms are generally heavier, more costly, and require more labor during assembly.

### SUMMARY OF INVENTION

An embodiment contemplates a snap-in glass carrier engageable with a window regulator assembly for snap fitting a movable door glass with a glass retention hole to the snap-in glass carrier. The snap-in glass carrier may comprise a glass carrier base and a spring finger. The spring finger may extend in a cantilevered fashion from the glass carrier base and include a glass retention barb spaced from the base and engaged with the glass retention hole. The spring finger may also include a spring finger neck adjacent to the glass carrier base and connecting to the glass carrier base at an attachment location, with the spring finger neck having a curvature configured to align the attachment location directly under an edge of the door glass when the door glass is mounted to the snap-in glass carrier.

An embodiment contemplates a snap-in glass carrier engageable with a window regulator assembly for snap fitting a movable door glass with a glass retention hole to the snap-in glass carrier. The snap-in glass carrier may comprise a glass carrier base and a spring finger. The spring finger may extend in a cantilevered fashion from the glass carrier base and include a glass retention barb spaced from the base and engaged with the glass retention hole and a spring finger neck adjacent to the glass carrier base and connecting to the glass carrier base at an attachment location. A first side of the glass retention barb may face away from the glass carrier base and be tapered to cause the spring finger to flex outward from the door glass during installation of the door glass to the snap-in glass carrier, and a second side of the glass retention barb may face toward the glass carrier base and include a first rib extending toward the glass carrier base that tapers away from the base as the first rib extends from a tip of the glass retention barb toward the spring finger.

An embodiment contemplates a snap-in glass carrier engageable with a window regulator assembly for snap fitting a movable door glass with a glass retention hole to the snap-in glass carrier. The snap-in glass carrier may include a glass carrier base and a spring finger, extending and cantilevered from the glass carrier base, including a glass retention barb spaced from the base and configured to engage with the glass retention hole, with a spring finger neck adjacent to the glass carrier base and connecting to the glass carrier base at an attachment location. The glass carrier may also include a support bridge finger extending from the glass carrier base generally parallel to the spring finger, and a support bridge connecting between the support bridge finger and the spring finger at an end opposite to the glass carrier base.

An advantage of an embodiment is that the retention force for retaining the window glass to the glass carrier is significantly increased while still employing a snap-in glass capability. Moreover, the snap-in glass carrier may be molded as a single piece. And, the snap-in configuration allows for reduced assembly complexity and time versus a clamp type of mechanism.

### BRIEF DESCRIPTION OF DRAWINGS

FIG. 1 is a schematic, perspective view of a portion of a movable window assembly for use in a vehicle door.

FIG. 2 is a perspective view of a snap-in glass carrier and a portion of a door glass.

FIG. 3 is a perspective view similar to FIG. 2, but showing the components from a different direction.

FIG. 4 is a view similar to FIG. 3, but without the door glass.

FIG. 5 is a perspective view of a portion of the snap-in glass carrier and door glass.

FIG. 6 is a sectional view taken along line 6-6 in FIG. 5.

FIG. 7 is a perspective view of a portion of the snap-in glass carrier.

FIG. 8 is another perspective view of a portion of the snap-in glass carrier.

### DETAILED DESCRIPTION

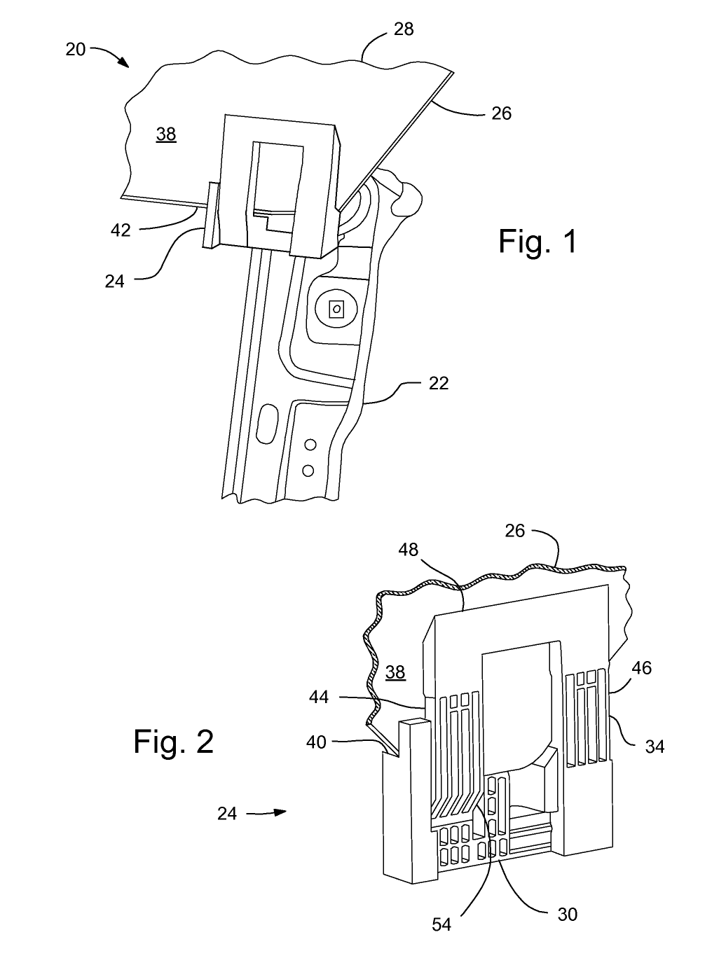

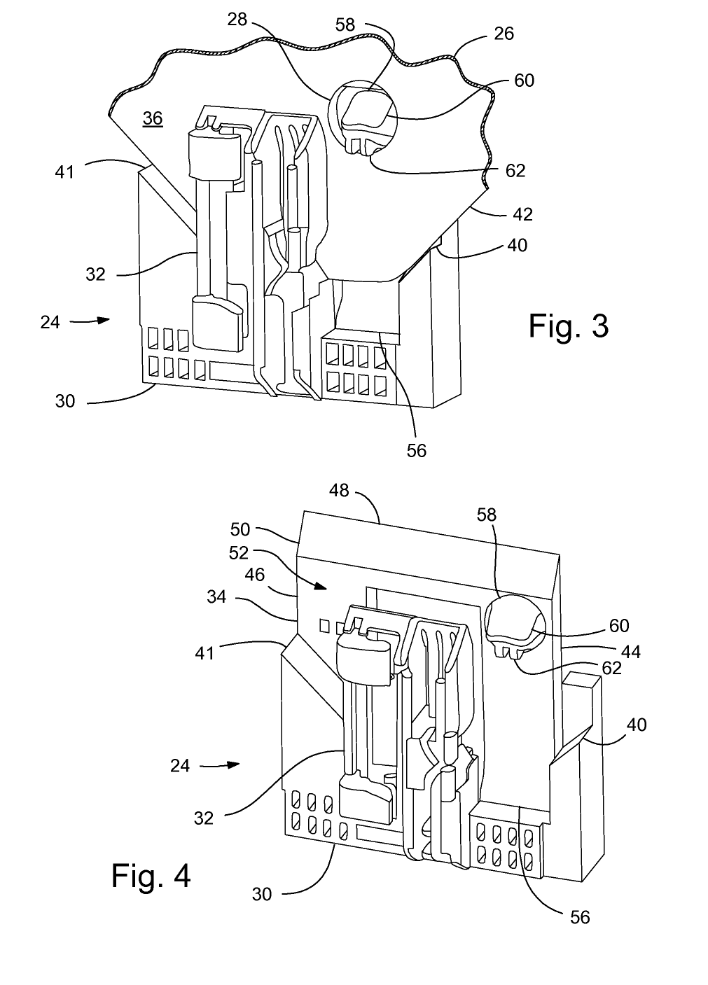

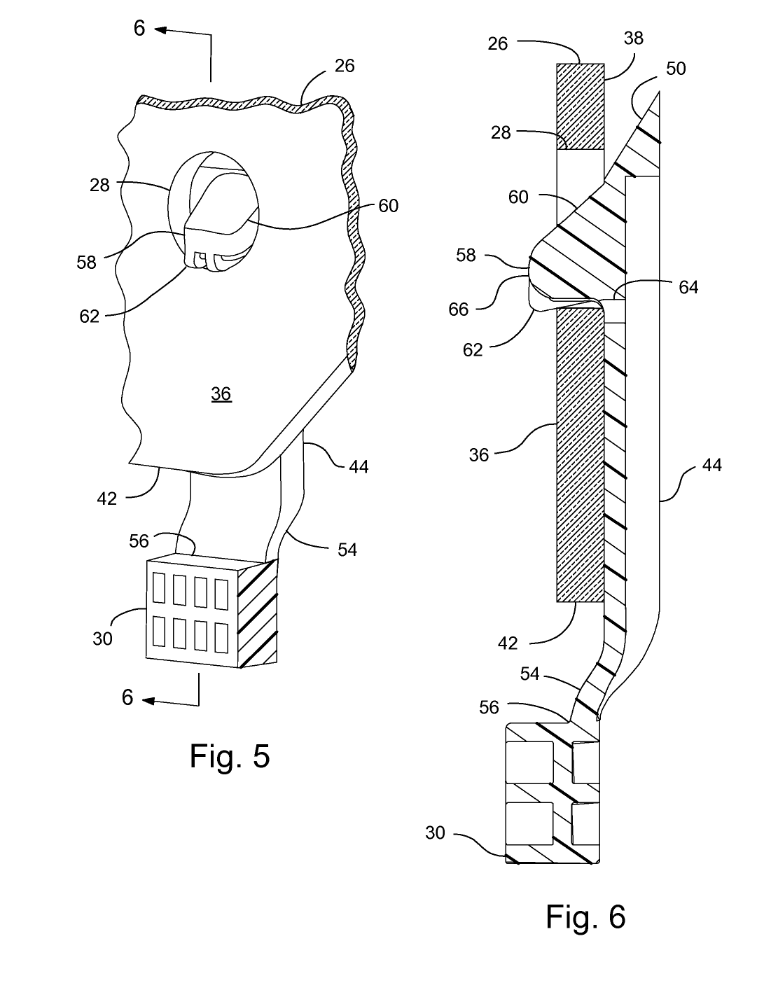

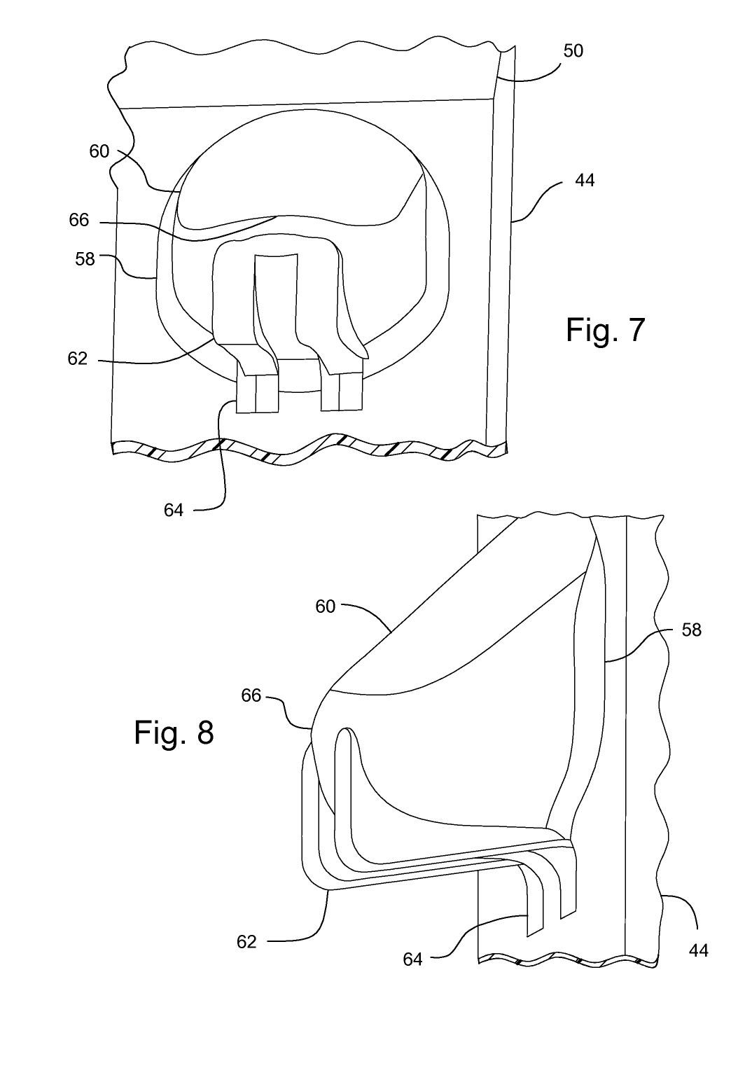

Referring to FIGS. 1-8, portions of a movable window assembly, indicated generally as 20, are shown. The movable window assembly 20 includes a window regulator assembly 22 (a portion of which is shown in FIG. 1). A snap-in glass carrier 24 is engaged and pulled up and down by the window regulator assembly 22. A movable side door glass 26 is retained by the snap-in glass carrier 24, which causes the up and down movement of the glass 26. The glass 26 includes a glass retention hole 28, and the glass carrier 24 is configured to allow the glass 26 to slide into the glass carrier 24 until the glass retention hole 28 is engaged by the glass carrier 24. This snap-in arrangement reduces the labor needed to assemble the door.

The glass carrier 24 may be molded as a single, monolithic piece, if so desired, and includes a glass carrier base 30 from which a window regulator attachment portion 32 and a glass retention portion 34 extend. The glass carrier base 30 also includes a first glass support ledge 40 and a second glass support ledge 41 upon which a bottom edge 42 of the glass 26 rests.

The window regulator attachment portion 32 is configured to engage and be driven up and down by the window regulator assembly 22. The window regulator attachment portion 32 also engages a first side 36 of the glass 26. The glass retention portion 34 engages a second, opposite side 38 of the glass 26 and engages the glass retention hole 28.

The glass retention portion 34 includes a spring finger 44 extending upward from the carrier base 30 adjacent to the first glass support ledge 40 and a support bridge finger 46 extending upward from the carrier base 30 adjacent to the second glass support ledge 41. A spring finger support bridge 48 extends between the spring finger 44 and the support bridge finger 46. The spring finger support bridge 48 includes a tapered face 50 that faces the second side of the glass 38 and helps guide the bottom edge 42 of the glass into a gap 52 between the window regulator attachment portion 32 and the glass retention portion 34. The support bridge 48 supports the spring finger 44 by creating an additional force directed towards the window, thus increasing the strength of the spring finger 44 and the glass retention force.

The spring finger 44 has a spring finger neck 54 that tapers to a narrower thickness as it extends down to the carrier base 30. Consequently, the elastic deflection of the spring finger 44 during assembly occurs mostly in the neck 54, allowing the remainder of the spring finger 44 to retain more stiffness. The spring finger neck 54 also curves inward as it extends downward toward the carrier base 30. This curvature is sufficient to cause the location of attachment 56 of the spring finger 44 to the carrier base 30 to be directly under the bottom edge 42 of the glass 26. This curvature and the tapering down cause the location of attachment 56 to act somewhat like a hinge location. With this hinge location being centered under the glass 26, a load between the glass carrier 24 and the glass 26 (caused by high window down loads) is in pure tension. This, in turn, allows for minimizing glass installation forces, while maintaining the ability to withstand relatively higher glass retention forces.

The spring finger 44 also includes a glass retention barb 58 that extends outward from the spring finger 44 into the gap 52. The glass retention barb 58 has a tapered upper surface 60 that causes the spring finger 44 to flex outward as the glass 26 is being slid into position in the gap 52. The glass retention barb 58 also includes a pair of saber-toothed ribs 62 located above molding holes 64 through the spring finger 44. The ribs 62 angle upward slightly as they extend inward from the tip 66 of the barb 58 toward the surface of the spring finger 44. With the holes 64, the upward angle of the ribs 62 can be achieved while still not adding to the mold complexity required to mold the glass carrier 24 (i.e., a pull-apart mold can still be employed if so desired)—all while maintaining sufficient strength in the retention barb 58 to hold the glass 26. Moreover, by having this upward angle on the ribs 62, high window down loads cause an increased horizontal engagement force between the ribs 62 and the glass 26, thus increasing the overall retention load capability of the glass carrier 24.

While certain embodiments of the present invention have been described in detail, those familiar with the art to which this invention relates will recognize various alternative designs and embodiments for practicing the invention as defined by the following claims.

What is claimed is:

1. A snap-in glass carrier engageable with a window regulator assembly for snap fitting a movable door glass with a glass retention hole to the snap-in glass carrier, the snap-in glass carrier comprising:
a glass carrier base; and
a spring finger, extending and cantilevered from the glass carrier base, including a glass retention barb spaced from the base and configured to engage with the glass retention hole, and a spring finger neck adjacent to the glass carrier base and connecting to the glass carrier base at an attachment location, the spring finger neck having a curvature configured to align the attachment location directly under an edge of the door glass when the door glass is mounted to the snap-in glass carrier.

2. The snap-in glass carrier of claim 1 wherein the spring finger neck tapers down to a narrower thickness adjacent to the attachment location.

3. The snap-in glass carrier of claim 1 including a support bridge finger extending generally parallel to the spring finger and a support bridge connecting between the support bridge finger and the spring finger at an end opposite to the glass carrier base.

4. The snap-in glass carrier of claim 3 wherein the support bridge includes a tapered face configured to direct the door glass to the glass retention barb as the door glass is inserted into the snap-in glass carrier.

5. The snap-in glass carrier of claim 1 wherein a first side of the glass retention barb faces away from the glass carrier base and is tapered to cause the spring finger to flex outward from the door glass during installation of the door glass to the snap-in glass carrier, and a second side of the glass retention barb faces toward the glass carrier base and includes a first rib extending outward toward the glass carrier base that tapers away from the base as the first rib extends from a tip of the glass retention barb toward the spring finger.

6. The snap-in glass carrier of claim 5 including a second rib extending outward toward the glass carrier base that tapers away from the base as the second rib extends from a tip of the glass retention barb toward the spring finger.

7. The snap-in glass carrier of claim 5 wherein the spring finger includes a molding hole extending through the spring finger adjacent to the taper of the first rib.

8. The snap-in glass carrier of claim 1 including a window regulator attachment portion extending from the glass carrier base and configured to define a gap between the window regulator attachment portion and the spring finger for receiving the door glass therebetween.

9. The snap-in glass carrier of claim 1 wherein the glass carrier base includes a glass support ledge configured to support the edge of door glass when the door glass is mounted to the snap-in glass carrier.

10. A snap-in glass carrier engageable with a window regulator assembly for snap fitting a movable door glass with a glass retention hole to the snap-in glass carrier, the snap-in glass carrier comprising:
a glass carrier base; and
a spring finger, extending and cantilevered from the glass carrier base, including a glass retention barb spaced from the base and configured to engage with the glass retention hole, and a spring finger neck adjacent to the glass carrier base and connecting to the glass carrier base at an attachment location, wherein a first side of the glass retention barb faces away from the glass carrier base and is tapered to cause the spring finger to flex outward from the door glass during installation of the door glass to the snap-in glass carrier, and a second side of the glass retention barb faces toward the glass carrier base and includes a first rib extending toward the glass carrier base that tapers away from the base as the first rib extends from a tip of the glass retention barb toward the spring finger.

11. The snap-in glass carrier of claim 10 including a second rib extending outward toward the glass carrier base that tapers away from the base as the second rib extends from a tip of the glass retention barb toward the spring finger.

12. The snap-in glass carrier of claim 11 wherein the spring finger includes a first molding hole extending through the spring finger adjacent to the taper of the first rib and a second molding hole extending through the spring finger adjacent to the taper of the second rib.

13. The snap-in glass carrier of claim 10 wherein the spring finger includes a molding hole extending through the spring finger adjacent to the taper of the first rib.

14. The snap-in glass carrier of claim 10 wherein the spring finger neck tapers down to a narrower thickness adjacent to the attachment location.

15. The snap-in glass carrier of claim 10 including a support bridge finger extending generally parallel to the spring finger and a support bridge connecting between the support bridge finger and the spring finger at an end opposite to the glass carrier base.

16. The snap-in glass carrier of claim 15 wherein the support bridge includes a tapered face configured to direct the door glass to the glass retention barb as the door glass is inserted into the snap-in glass carrier.

17. A snap-in glass carrier engageable with a window regulator assembly for snap fitting a movable door glass with a glass retention hole to the snap-in glass carrier, the snap-in glass carrier comprising:
a glass carrier base;
a spring finger, extending and cantilevered from the glass carrier base, including a glass retention barb spaced from the base and configured to engage with the glass retention hole, and a spring finger neck adjacent to the glass carrier base and connecting to the glass carrier base at an attachment location;
a support bridge finger extending from the glass carrier base generally parallel to the spring finger; and
a support bridge connecting between the support bridge finger and the spring finger at an end opposite to the glass carrier base.

18. The snap-in glass carrier of claim 17 wherein the support bridge includes a tapered face configured to direct the door glass to the glass retention barb as the door glass is inserted into the snap-in glass carrier.

19. The snap-in glass carrier of claim 17 including a window regulator attachment portion extending from the glass carrier base and configured to define a gap between the window regulator attachment portion and the spring finger for receiving the door glass therebetween.

20. The snap-in glass carrier of claim 17 wherein the glass carrier base includes a glass support ledge configured to support the edge of door glass when the door glass is mounted to the snap-in glass carrier.
